(19) United States
(12) Patent Application Publication
(10) Pub. No.: US 2026/0068005 A1
(43) Pub. Date: Mar. 5, 2026

(54) A Method of Forming A Susceptor

(71) Applicant: JT International SA, Geneva (CH)

(72) Inventors: Maurits Maks, Zwolle (NL); René Van De Meeberg, Zwolle (NL)

(73) Assignee: JT International SA, Geneva (CH)

(21) Appl. No.: 19/107,158

(22) PCT Filed: Nov. 17, 2023
(86) PCT No.: PCT/EP2023/082209

§ 371 Date: Feb. 27, 2025

(30) Foreign Application Priority Data
Nov. 25, 2022 (EP) 22209617.4

(51) Int. Cl. H05B 6/10; A24F 40/465; A24F 40/70; C21D 7/10; C21D 8/10

(52) U.S. Cl. CPC H05B 6/108; A24F 40/465; A24F 40/70; C21D 7/10; C21D 8/10; C21D 2211/008

(57) ABSTRACT

A susceptor for an induction heating assembly and a method of forming such. The method comprises providing a blank. The blank comprises austenitic stainless steel. The method further comprises subjecting the blank to a plastic deformation step causing an α′-martensite phase to be formed in the austenitic stainless steel which increases its magnetic permeability.

### TECHNICAL FIELD

The present disclosure relates generally to a method of forming a susceptor, and more particularly to a method of forming a susceptor for an induction heating assembly.

### TECHNICAL BACKGROUND

Aerosol generating devices (also known as vaporisers) which heat, rather than burn or combust, an aerosol generating substrate to produce an aerosol for inhalation by a user of the device have become popular with consumers in recent years as an alternative to the use of traditional tobacco products.

Various devices and systems are available which can use one of a number of different approaches to provide heat to the aerosol generating substrate. One such approach is to provide an induction heating assembly. Such assemblies employ an electromagnetic field generator, such as an induction coil, to generate an alternating electromagnetic field that couples with, and inductively heats, a susceptor heating element. Heat from the susceptor is transferred, for example by conduction, to the substrate and an aerosol is generated as the substrate is heated for inhalation by a user of the device.

In use, susceptors are arranged in close proximity or in contact with the aerosol generating substrate and are thus preferably formed of materials which resist corrosion. In this regard, austenitic stainless steel is a suitable susceptor material because it is highly resistant to corrosion. However, austenitic stainless steel susceptors do not have sufficient magnetic permeability to provide efficient heating within an induction heating assembly.

There is, therefore, a need to address this shortcoming.

### SUMMARY OF THE DISCLOSURE

According to a first aspect of the present disclosure, there is provided a method of forming a susceptor for an induction heating assembly, the method comprising:
providing a blank, wherein the blank comprises austenitic stainless steel; and
subjecting the blank to a plastic deformation step causing an α′-martensite phase to be formed in the austenitic stainless steel which increases its magnetic permeability.

Subjecting the blank to a plastic deformation step changes the micro grain structure of the austenitic stainless steel to include an α′-martensite phase resulting in an increase in its magnetic permeability. This improves the heating efficiency of the susceptor within an induction heating assembly, and thus improves performance. The susceptor remains highly resistant to corrosion.

Possibly, the plastic deformation step comprises:
deep drawing the blank to form a side wall of the susceptor, wherein the side wall has an open first end and a base at a second end, opposite the first end, the base closing the side wall at the second end.

Deep drawing the blank may include forming a flange portion that extends radially outwardly from the side wall at the open first end. Alternatively, a flange portion may be formed after deep drawing in a separate step.

Possibly, the method further comprises:
cutting the side wall to remove the base to open the second end.

The method may further comprise cutting the side wall to remove the flange portion.

The side wall may comprise one or more substantially flat sides. In other examples, the side wall may be a cylindrical side wall having a circular or oval cross section. The method may further comprise selectively deforming the cylindrical side wall. The cylindrical side wall may be selectively deformed to provide one or more substantially flat portions or one or more substantially flat sides. The cylindrical side wall may be selectively deformed by hydroforming or mechanical pressing.

The method may further comprise selectively deforming the side wall to form one or more inwardly directed protrusions on an inner surface of the side wall by indenting an outer surface of the side wall.

In use, the inwardly directed protrusions extend into the heating compartment to compress the aerosol generating substrate. By compressing the aerosol generating substrate, heat can be transferred more efficiently to the aerosol generating substrate and more rapid heating can be achieved, whilst at the same time maximising energy efficiency. The compression of the aerosol generating substrate improves thermal conduction through the aerosol generating substrate, for example by eliminating air gaps.

The method may further comprise:
annealing the side wall; and
selectively deforming a portion of the annealed side wall.

The magnetic permeability of the susceptor is selectively increased at locations corresponding to portions of the annealed side wall which have been selectively deformed.

The side wall may have an inner diameter of from 5 mm to 9 mm. Susceptors having a side wall with these inner diameter dimensions optimise the balance between the quantity of vapour generated and the time (and thus energy) required to generate the vapour, thus further improving performance.

The side wall may have a thickness of 200 μm or less. The side wall may have a thickness of from 90 μm to 110 μm. Susceptors having a side wall with these thickness dimensions may be particularly suitable for being inductively heated during use.

The side wall may have an axial length of from 0.5 mm to 20 mm. Susceptors having these axial length dimensions optimise the balance between the quantity of vapour generated and the time (and thus energy) required to generate the vapour, thus further improving performance.

The austenitic stainless steel may be AISI 304 or AISI 321.

The blank may be disk shaped.

According to a second aspect of the present disclosure, there is provided a susceptor for an induction heating assembly, the susceptor being formed of austenitic stainless steel comprising an α′-martensite phase. The susceptor may be formed by the method according to any of the preceding paragraphs.

According to a third aspect of the present disclosure, there is provided an aerosol generating device comprising an induction heating assembly, wherein the induction heating assembly comprises a susceptor, wherein the susceptor is formed of austenitic stainless steel comprising an α′-martensite phase. The susceptor may be formed by the method according to any of the preceding paragraphs.

According to a fourth aspect of the present disclosure, there is provided an induction heating assembly comprising a susceptor, the susceptor being formed of austenitic stainless steel comprising an α′-martensite phase. The susceptor may be formed by the method according to any of the preceding paragraphs.

According to a fifth aspect of the present disclosure, there is provided an aerosol generating system comprising an aerosol generating device and an aerosol generating substrate, wherein the aerosol generating device comprises an induction heating assembly, wherein the induction heating assembly comprises a susceptor, the susceptor being formed of austenitic stainless steel comprising an α′-martensite phase. The susceptor may be formed by the method according to any of the preceding paragraphs.

A susceptor formed of austenitic stainless steel having a micro grain structure including an α′-martensite phase has sufficient magnetic permeability to provide efficient heating within an induction heating assembly. This improves performance. The susceptor remains highly resistant to corrosion.

### BRIEF DESCRIPTION OF THE DRAWINGS

FIG. 1 is a diagrammatic view of an aerosol generating system;

FIG. 2 is a diagrammatic perspective cutaway view of an induction heating assembly of an aerosol generating device:

FIG. 3 is a diagrammatic perspective cutaway view of another induction heating assembly of another aerosol generating device:

FIG. 4 illustrates a method of forming a susceptor for an induction heating assembly:

FIG. 5 is a diagrammatic perspective view of a blank in relation to block A of the method of FIG. 4:

FIG. 6 is a diagrammatic perspective view of an arrangement in relation to block B of the method of FIG. 4:

FIG. 7 is a diagrammatic bottom view of the arrangement of FIG. 6;

FIG. 8 is a diagrammatic perspective view of an arrangement in relation to block C of the method of FIG. 4:

FIG. 9 is a diagrammatic bottom view of the arrangement of FIG. 8:

FIG. 10 is a diagrammatic perspective view of an arrangement in relation to block D of the method of FIG. 4:

FIG. 11 is a diagrammatic perspective view of an arrangement in relation to block H of the method of FIG. 4:

FIG. 12 is a diagrammatic perspective view of another susceptor formed by the method of FIG. 4; and

FIG. 13 is a diagrammatic cross-sectional view of the arrangement of FIG. 12.

### DETAILED DESCRIPTION OF EMBODIMENTS

Embodiments of the present disclosure will now be described by way of example only and with reference to the accompanying drawings.

Examples of the disclosure provide a method of forming a susceptor 10. Examples of the disclosure also provide a susceptor 10 which may be formed by the described method, i.e., being a product of the described method.

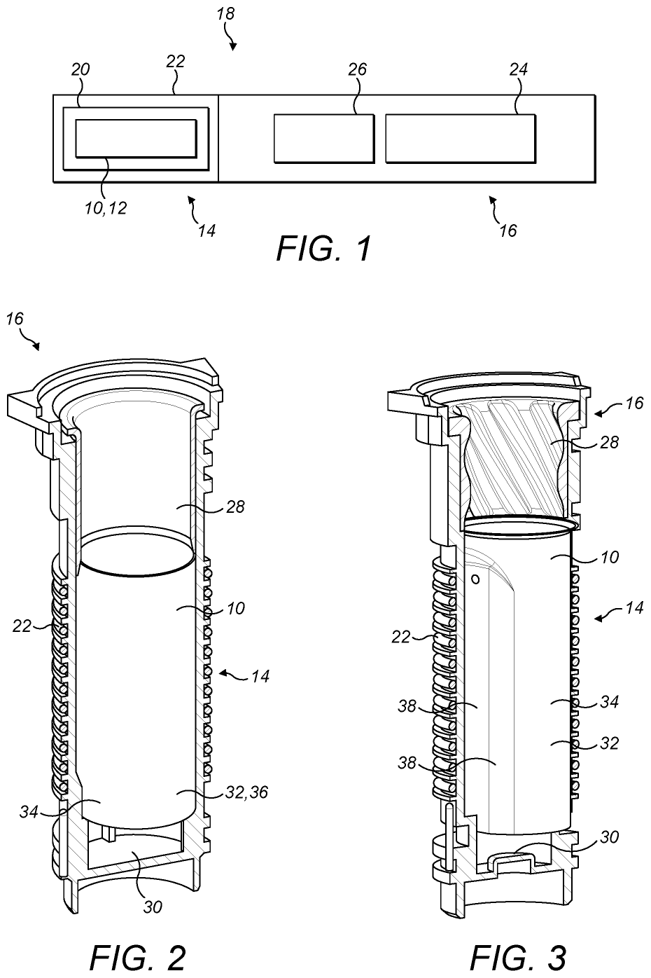

As shown diagrammatically in FIG. 1, a susceptor 10 according to examples of the disclosure is useable as a heating element 12 as part of an induction heating assembly 14, i.e., an induction heating system. The induction heating assembly 14 is comprised in an aerosol generating system 18. An aerosol generating system 18 comprises an aerosol generating device 16 (also known as a vaporiser) and an aerosol generating substrate 20. An aerosol generating device 16 is a hand-held, portable, device, by which it is meant that a user is able to hold and support the device 16 unaided, in a single hand.

In some examples, the induction heating assembly 14 is comprised in the aerosol generating device 16.

Susceptors 10 according to examples of the disclosure comprise an electrically conductive material. In examples of the disclosure, the susceptor 10 comprises austenitic stainless steel. In use, an induction coil 22, i.e., an electromagnetic field generator, comprised in the induction heating assembly 14 is arranged to be energised to generate an alternating electromagnetic field that couples with, and inductively heats, the susceptor 10 due to eddy currents and magnetic hysteresis losses resulting in a conversion of energy from electromagnetic to heat. Susceptors 10 according to examples of the disclosure are thus inductively heatable. Heat from the susceptor 10 is transferred, for example by conduction, radiation and convection, to the aerosol generating substrate 20 to heat the aerosol generating substrate 20 (without burning or combusting the aerosol generating substrate 20) thereby generating a vapour which cools and condenses to form an aerosol for inhalation by a user of the aerosol generating device 16.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The induction coil 22 is energised by a power source 24 of the aerosol generating device 16, such as a battery. Aerosol generating devices 10 typically include a controller 26 and a user interface for controlling the operation of the aerosol generating device 16 via the controller 26.

The controller 26 is configured to detect the initiation of use of the aerosol generating device 16, for example, in response to a user input, such as a button press to activate the aerosol generating device 16, or in response to a detected airflow through the aerosol generating device 16. As will be understood by one of ordinary skill in the art, an airflow through the aerosol generating device 16 is indicative of a user inhalation or ‘puff’. The aerosol generating device 16 may, for example, include a puff detector, such as an airflow sensor (not shown), to detect an airflow through the aerosol generating device 16.

The controller 26 includes electronic circuitry. The power source 24 and the electronic circuitry may be configured to operate at a high frequency. For example, the power source 24 and the electronic circuitry may be configured to operate at a frequency of between approximately 80 KHz and 500 kHz, possibly between approximately 150 kHz and 250 kHz, and possibly at approximately 200 kHz. The power source 24 and the electronic circuitry could be configured to operate at a higher frequency, for example in the MHz range, if required.

The induction coil 22 may be arranged around the susceptor 10, for example to surround or fully surround the susceptor 10. The induction coil 22 may be substantially helical in shape. The induction coil 22 may be annular. The induction coil 22 may comprise a Litz wire or a Litz cable. It will, however, be understood that other materials could be used. The induction coil 22 may be arranged to operate in use with a fluctuating electromagnetic field having a magnetic flux density of between approximately 20 mT and approximately 2.0 T at the point of highest concentration.

FIG. 2 provides a cutaway drawing illustrating diagrammatically an induction heating assembly 14 of an aerosol generating device 16. The induction heating assembly 14 comprises a susceptor 10 according to examples of the disclosure.

Referring to FIG. 2, the induction heating assembly 14 has an arrangement in which a susceptor 10 is arranged around the periphery of a heating compartment 28 configured for receiving an aerosol generating substrate 20. Alternatively, in other non-illustrated arrangements a susceptor 10 may be arranged to project into a heating compartment 28 from an end 30 of the heating compartment 28 to penetrate the aerosol generating substrate 20 when the aerosol generating substrate 20 is received in the heating compartment 28. In such examples, the susceptor 10 may be a blade or pin.

In the arrangement of FIG. 2, an induction coil 22 is arranged around the susceptor 10 outside the heating compartment 28 to surround the susceptor 10. The induction coil 22 is helical in shape.

In the arrangement of FIG. 2, the susceptor 10 is comprised in the aerosol generating device 16. In other arrangements, the susceptor 10 may instead be provided in the aerosol generating substrate 20 during manufacture.

The susceptor 10 illustrated in FIG. 2 is an outer or peripheral susceptor, i.e., locatable on the outside of an aerosol generating substrate 20. In other non-illustrated examples, susceptors 10 according to examples of the disclosure may be central or inner susceptors, i.e., locatable within an aerosol generating substrate 20 or on the inside of an aerosol generating substrate 20.

Susceptors 10 according to examples of the disclosure have a side wall 32. The susceptor 10 illustrated in FIG. 2 is a susceptor tube 34 having a cylindrical side wall 36 with a circular cross section. Accordingly, in the example of FIG. 2 the susceptor 10 is cylindrical. The susceptor 10 of FIG. 2 is open-ended, hollow, and elongate.

FIG. 3 provides a cutaway drawing illustrating diagrammatically another induction heating assembly 14 of another aerosol generating device 16. The induction heating assembly 14 comprises another susceptor 10 according to examples of the disclosure. The induction heating assembly 14 is similar to the induction heating assembly 14 described above with reference to FIG. 2 and corresponding components are identified using the same reference numerals. Only the differences relative to the arrangement of FIG. 2 will hereby be described.

The susceptor 10 of FIG. 3 is a susceptor tube 34 having a side wall 32 comprising a plurality of flat portions 38. In other examples, for instance as illustrated in FIG. 12 described below, susceptors 10 according to examples of the disclosure may comprise one or more substantially flat sides 52.

Accordingly, in examples of the disclosure the susceptor 10 side wall 32 may be cylindrical having a circular or oval cross section, or may comprise one or more substantially flat portions 38, or may comprise one or more substantially flat sides 52, i.e., flat side walls, or may comprise protrusions 50, i.e., deformed portions, as described below. Susceptors 10 may be open-ended, hollow, and elongate.

Specific examples of susceptors 10 according to examples of the disclosure include, but are not limited to, a particulate susceptor, a susceptor filament, a susceptor mesh, a susceptor wick, a susceptor pin, a susceptor rod, a susceptor blade, a susceptor strip, a susceptor sleeve, a susceptor tube, and a susceptor ring. A susceptor strip may be elongate.

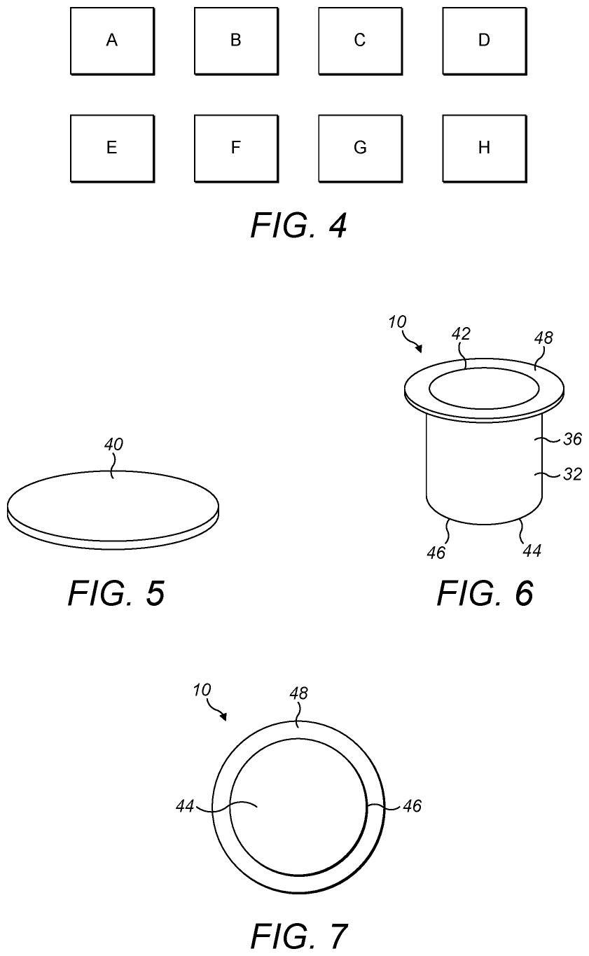

Blocks A to C of FIG. 4 illustrate a method of forming a susceptor 10 for an induction heating assembly 14. FIGS. 5 to 9 illustrate diagrammatically the features and arrangements described in relation to blocks A to C of FIG. 4.

Referring to block A, and with reference to FIG. 5, the method comprises providing a blank 40, wherein the blank 40 comprises austenitic stainless steel and subjecting the blank to a plastic deformation step causing an α′-martensite phase to be formed in the austenitic stainless steel which increases its magnetic permeability.

In some examples, the blank 40 is made from austenitic stainless steel and thus consists of austenitic stainless steel. Austenitic stainless steel is highly resistant to corrosion, which is a desirable property for a susceptor material particularly as in use susceptors 10 are arranged in close proximity or in contact with aerosol generating substrate 20. The austenitic stainless steel may be AISI (American Iron and Steel Institute) 304 or AISI 321.

In the illustrated example, the blank 40 is planar. Accordingly, the blank 40 has a flat or level surface that continues in all directions. In the illustrated example, the blank 40 is disk shaped. The blank 40 may be sheet material.

Referring to block B, and with reference to FIGS. 6 and 7, optionally the plastic deformation step comprises deep drawing the blank 40 to form a side wall 32 with an open first end 42 and a base 44 at a second end 46, opposite the first end 42. The base 44 closes the side wall 32 at the second end 46. The base 44 fully closes the side wall 32 at the second end 46. The base 44 is integral with the side wall 32. The arrangement of FIGS. 6 and 7 is therefore cup shaped. The arrangement of FIGS. 6 and 7 has a cylindrical side wall 36 with a circular cross section.

The deep drawing of the blank 40 includes forming a flange portion 48 that extends radially outwardly from the side wall 32 at the open first end 42.

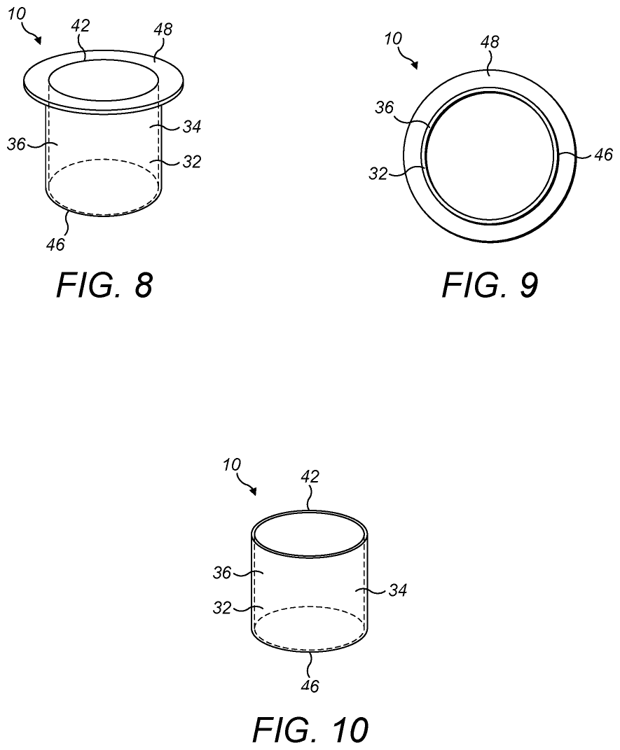

Referring to block C, and with reference to FIGS. 8 and 9, optionally the method further comprises cutting the side wall 32 to remove the base 44 to open the second end 46. Accordingly, the base 44, i.e., the closed end, is sheared from the side wall 32 following the deep drawing process. The arrangement of FIGS. 8 and 9 is a susceptor 10 in the form of a susceptor tube 34 having a cylindrical side wall 36 with a circular cross section. The flange portion 48 extends radially outwardly from the side wall 32 at the open first end 42. The susceptor tube 34 of FIGS. 8 and 9 is open-ended, hollow, and elongate.

Without being bound by theory, subjecting the blank to a plastic deformation step changes the micro grain structure of the austenitic stainless steel to include an α′-martensite phase resulting in an increase in its magnetic permeability. This improves the heating efficiency of the susceptor 10 within an induction heating assembly 14, and thus improves performance. The susceptor remains highly resistant to corrosion.

The presence of an α′-martensite phase can be proven by checking the microstructure of the austenitic stainless steel on a light microscope.

Providing the intermediate structure of FIGS. 6 and 7 with a base 44 provides a degree of strengthening and providing a flange portion 48 also provides its own degree of strengthening. The flange portion 48 (i.e., collar) thus sustains or holds the susceptor 10. However, providing both a base 44 and a flange portion 48 provides a greater degree of strengthening than either the base 44 or the flange portion 48 alone. This is largely due to the flange portion 48 and the base 44 being located at opposing ends of the side wall 32, meaning that neither end of the side wall 32 is unsupported. Accordingly, the side wall 32 is strengthened to better resist failure, for instance, during further deformation following deep drawing, e.g., to form protrusions 50 or to flatten at least a portion of the side wall 32 as described below.

This is an effective method for forming a susceptor 10 and can be used to provide a very thin side wall 32, for instance, in the range described below. In some examples, the deep drawing process involves pressing an austenitic stainless-steel blank 40 with a punch tool (not shown) to force it into a shaped forming die (not shown). The austenitic stainless-steel blank 40 is radially drawn into a forming die by the mechanical action of the punch. Accordingly, the austenitic stainless-steel blank is deformed. In some examples, by using a series of progressively smaller punch tools and dies, a tubular structure can be formed which has a closed end 46 (i.e., a base 44 at second end 46) and with a susceptor tube 34 which is deeper than the distance across the susceptor tube 34 (it is the susceptor tube 34 being relatively longer than it is wide which leads to the term “deep drawing”). Due to being formed in this manner, the side wall 32 of a susceptor tube 34 formed in this way may be the same thickness as the original sheet metal blank 40. Similarly, the base 44 formed in this way may be the same thickness as the initial sheet metal blank 40.

The flange portion 48 can be formed at the first end 42 of the susceptor tube 34 by leaving a rim of the original sheet metal blank 40 extending outwardly at the opposite end of the side wall 32 to the base 44 (i.e., starting with more material in the blank 40 than is needed to form the susceptor tube 34 and base 44). Alternatively, a flange portion 48 can be formed afterwards in a separate step involving one or more of cutting, bending, rolling, swaging, etc.

In the examples of FIGS. 6 to 9, the side wall 32 of the susceptor 10 is a cylindrical side wall 36 with a circular cross section.

Block D of FIG. 4 illustrates an optional step in relation to the method of forming a susceptor 10 according to examples of the disclosure. FIG. 10 illustrates diagrammatically the features described in relation to block D.

Referring to block D, and with reference to FIG. 10, in some examples the method further comprises optionally cutting the side wall 32 to remove the flange portion 48. Accordingly, in such examples the method comprises trimming the ends (i.e., both of ends 42, 46) of the side wall 32.

The arrangement of FIG. 10 is a susceptor tube 34 having a cylindrical side wall 36 with a circular cross section. The flange portion 48 has been removed. In the example of FIG. 10, the susceptor tube 34 is cylindrical, open-ended, hollow, and elongate.

Block E of FIG. 4 illustrates another optional step in relation to the method of forming a susceptor 10 according to examples of the disclosure. Referring to block E, in examples wherein the side wall 32 of the susceptor 10 formed by deep drawing is cylindrical having a circular or oval cross section (i.e., a cylindrical susceptor 10), the method may further comprise selectively deforming the cylindrical side wall 36. The cylindrical side wall 36 may be selectively deformed to provide one or more substantially flat sides 52 or one or more substantially flat portions 38, for instance, as illustrated in FIG. 3. An arrangement comprising two flat sides 52 is illustrated in FIGS. 12 and 13. However, in relation to FIGS. 12 and 13, the flat sides 52 are formed by a different mechanism, as described below. The cylindrical side wall 36 may be selectively deformed by hydroforming or mechanical pressing. The cylindrical side wall 36 may be selectively deformed prior to cutting the cylindrical side wall 36 to remove the base 44 and/or flange portion 48.

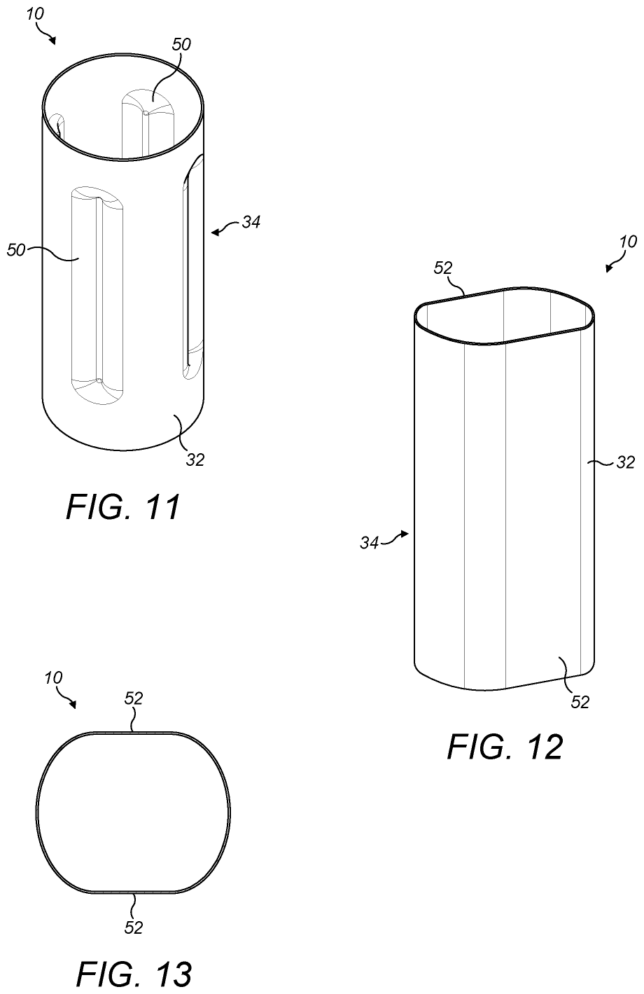

Block F of FIG. 4 illustrates another optional step in relation to the method of forming a susceptor 10 according to examples of the disclosure. Referring to block F, in some examples the method further comprises optionally selectively deforming the side wall 32 to form one or more inwardly directed protrusions 50 (as illustrated in FIG. 11 described below) on an inner surface of the side wall 32 by indenting an outer surface of the side wall 32. The outer surface of the side wall 32 may be indented by hydroforming or mechanical pressing. The side wall 32 may be selectively deformed prior to cutting the side wall 32 to remove the base 44 and/or flange portion 48. The side wall 32 may be a cylindrical side wall 36 having a circular or oval cross section as illustrated in FIG. 11 (i.e., a cylindrical susceptor 10) or may have a different geometry.

In use, the inwardly directed protrusions 50 extend into the heating compartment 28 to compress the aerosol generating substrate 20. By compressing the aerosol generating substrate 20, heat can be transferred more efficiently to the aerosol generating substrate 20 and more rapid heating can be achieved, whilst at the same time maximising energy efficiency. The compression of the aerosol generating substrate 20 improves thermal conduction through the aerosol generating substrate 20, for example by eliminating air gaps.

Block G of FIG. 4 illustrates an optional step in relation to the method of forming a susceptor 10 according to examples of the disclosure. Referring to block G, in some examples, the method further comprises optionally annealing the side wall 32.

Block H of FIG. 4 illustrates an optional step in relation to the method of forming a susceptor 10 according to examples of the disclosure. Referring to block H, and with reference to FIG. 11, the method further comprises optionally selectively deforming a portion of the annealed side wall 32.

The arrangement of FIG. 11 is a susceptor 10 in the form of a susceptor tube 34 having an annealed side wall 32 comprising a plurality of protrusions 50, i.e., selectively deformed portions. In some examples, the protrusions 50 may include flat portions 38. The magnetic permeability of the susceptor 10 is selectively increased at locations corresponding to the protrusions 50 of the annealed side wall 32.

The arrangement of FIGS. 12 and 13 is a susceptor 10 in the form of a susceptor tube 34 having a side wall 32 comprising two flat sides 52, i.e., flat side walls. In this example, the flat sides 52 have been formed directly from a blank 40 by deep drawing, i.e., the flat sides 52 have been introduced by deep drawing based on the configuration of the punch tool and/or forming die. The side wall 32 of susceptor tube 34 of FIGS. 12 and 13 has an axial length of 16 mm. Accordingly, the side wall 32 of susceptors 10 according to examples of the disclosure may comprise or one or more substantially flat sides 52.

In some examples, the side wall 32 of susceptors 10 according to examples of the disclosure has an inner, i.e., internal, diameter of from 5 mm to 9 mm. The side wall 32 preferably may have an inner diameter of from 5 mm to 8 mm, or of from 5.5 mm to 7.5 mm, or most preferably of 7 mm. Susceptors 10 having a side wall 32 with these inner diameter dimensions optimise the balance between the quantity of vapour generated and the time (and thus energy) required to generate the vapour, thus further improving performance.

In some examples, the side wall 32 of susceptors 10 according to examples of the disclosure has a thickness of 200 μm or less. Preferably, the side wall 32 may have a thickness of from 30 μm to 200 μm, or may have a thickness of from 50 μm to 170 μm, or more preferably may have a thickness of from 70 μm to 150 μm, or most preferably may have a thickness of from 90 μm to 110 μm. The side wall 32 may have a thickness of 100 μm. Susceptors 10 having a side wall 32 with these thickness dimensions may be particularly suitable for being inductively heated during use.

In some examples, the side wall 32 of susceptors 10 according to examples of the disclosure has an axial length of from 0.5 mm to 20 mm. In some examples, the susceptor 10 has an axial length of from 3 mm to 5 mm, or may have an axial length of 4 mm. Susceptors 10 having these axial length dimensions optimise the balance between the quantity of vapour generated and the time (and thus energy) required to generate the vapour, thus further improving performance.

Examples of the disclosure also provide a susceptor 10 for an induction heating assembly 14, the susceptor 10 being formed of austenitic stainless steel comprising an α′-martensite phase. The susceptor 10 may be formed by the method described above.

Examples of the disclosure also provide an induction heating assembly 14 comprising a susceptor 10, the susceptor 10 being formed of austenitic stainless steel comprising an α′-martensite phase. The susceptor 10 may be formed by the method described above.

Examples of the disclosure also provide an aerosol generating device 16 comprising an induction heating assembly 14, wherein the induction heating assembly 14 comprises a susceptor 10, the susceptor 10 being formed of austenitic stainless steel comprising an α′-martensite phase. The susceptor 10 may be formed by the method described above.

Examples of the disclosure also provide an aerosol generating system comprising an aerosol generating device 16 and an aerosol generating substrate 20. The aerosol generating device 16 comprises an induction heating assembly 14, wherein the induction heating assembly 14 comprises a susceptor 10, the susceptor 10 being formed of austenitic stainless steel comprising an α′-martensite phase. The susceptor 10 may be formed by the method described above.

A susceptor 10 formed of austenitic stainless steel having a micro grain structure including an α′-martensite phase has sufficient magnetic permeability to provide efficient heating within an induction heating assembly 14. This improves performance. The susceptor 10 remains highly resistant to corrosion.

The Figures also illustrate a method of manufacturing an aerosol generating device 16 comprising an induction heating assembly 14, wherein the induction heating assembly 14 comprises a susceptor 10, the susceptor 10 being formed of austenitic stainless steel comprising an α′-martensite phase. The susceptor 10 may be formed by the method described above.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense: that is to say, in the sense of “including, but not limited to”.

1. A method of forming a susceptor for an induction heating assembly, the method comprising:
providing a blank, wherein the blank comprises austenitic stainless steel; and
subjecting the blank to a plastic deformation step causing an α′-martensite phase to be formed in the austenitic stainless steel which increases its magnetic permeability.

2. The method according to claim 1, wherein the plastic deformation step comprises:
deep drawing the blank to form a side wall of the susceptor, wherein the side wall has an open first end and a base at a second end, opposite the first end, the base closing the side wall at the second end, wherein deep drawing the blank preferably includes forming a flange portion that extends radially outwardly from the side wall at the open first end.

3. The method according to claim 2, wherein the method further comprises:
cutting the side wall to remove the base to open the second end; and wherein the method optionally further comprises:
cutting the side wall to remove the flange portion.

4. The method according to claim 2, wherein the side wall comprises one or more substantially flat sides (52).

5. The method according to claim 2, wherein the side wall is a cylindrical side wall having a circular or oval cross section.

6. The A method according to claim 5, wherein the method further comprises:
selectively deforming the cylindrical side wall.

7. The A-method according to claim 6, wherein the cylindrical side wall is selectively deformed to provide one or more substantially flat portions or one or more substantially flat sides.

8. The method according to claim 6, wherein the cylindrical side wall is selectively deformed by hydroforming or mechanical pressing.

9. The method according to claim 2, wherein the method further comprises:
selectively deforming the side wall to form one or more inwardly directed protrusions on an inner surface of the side wall by indenting an outer surface of the side wall.

10. The method according to claim 2, wherein the method further comprises:
annealing the side wall; and
selectively deforming a portion of the annealed side wall.

11. The A method according to claim 2, wherein the side wall has an inner diameter of from 5 mm to 9 mm.

12. The A method according to claim 2, wherein the side wall has a thickness of 200 μm or less.

13. A The method according to claim 1, wherein the austenitic stainless steel is AISI 304 or AISI 321.

14. A susceptor for an induction heating assembly, the susceptor being formed of austenitic stainless steel comprising an α′-martensite phase.

15. An aerosol generating device comprising an induction heating assembly, wherein the induction heating assembly comprises a susceptor, wherein the susceptor is formed of austenitic stainless steel comprising an α′-martensite phase.
